(19) United States
(12) Patent Application Publication
(10) Pub. No.: US 2012/0002811 A1
(43) Pub. Date: Jan. 5, 2012

(54) SECURE OUTSOURCED COMPUTATION

(75) Inventor: Nigel Smart, Bristol (GB)

(73) Assignee: THE UNIVERSITY OF BRISTOL, Bristol (GB)

(21) Appl. No.: 12/827,247

(22) Filed: Jun. 30, 2010

(51) Int. Cl. H04L 9/00

(52) U.S. Cl. 380/255

(57) ABSTRACT

Secure outsourced computation on data can be achieved by transmitting shares of the data to respective computation servers; establishing respective connections between each of the computation servers and respective security modules, wherein each security module contains respective security data, the security data on the security modules being related by means of a Linear Secret Sharing Scheme; computing respective shares of a computation result in the computation servers, using the respective shares of the data and the respective security data; returning the shares of the computation result to a data owner; and obtaining the computation result from the respective shares of the computation result.

### BACKGROUND OF THE INVENTION

This invention relates to cryptography, and in particular relates to a method and a system that allows outsourced multi-party computation to be performed in a secure way. That is, an entity that is in possession of relevant data is able to outsource the computation of functions on that data to other parties, in a secure way, meaning that the other parties are not able to access the original data or the results of the computation.

The development of multi-party computation was one of the early achievements of theoretical cryptography. Since that time a number of papers have been published which look at specific application scenarios (e-voting, e-auctions), different security guarantees (computational vs unconditional), different adversarial models (active vs passive, static vs adaptive), different communication models (secure channels, broadcast) and different set-up assumptions (CRS, trusted hardware etc). We examine an application scenario in the area of cloud computing which we call Secure Outsourced Computation. We show that this variant produces less of a restriction on the allowable adversary structures than full multi-party computation. We also show that if one provides the set of computation engines (or Cloud Computing providers) with a small piece of isolated trusted hardware one can outsource any computation in a manner which requires less security constraints on the underlying communication model and at greater computational/communication efficiency than full multi-party computation.

In addition our protocol is highly efficient and thus of greater practicality than previous solutions, our required trusted hardware being particularly simple and with minimal trust requirements.

One of the crowning achievements in the early days of theoretical cryptography was the result that a set of parties, each with their own secret input, can compute any computable function of these inputs securely with polynomial overhead. Of course the above statement comes with some caveats, as to what we assume in terms of abilities of any adversaries and what assumptions we make of the underlying infrastructure. However, the concept of general Secure Multi-Party Computation (SMPC) has had considerable theoretical impact on cryptography and has even been deployed in practical applications. One can consider any complex secure computation as an example of SMPC, for example voting, auctions, payment systems etc. Indeed by specialising the application domain one can often obtain protocols which considerably outperform the general SMPC constructions.

In this patent we take a middle approach between general SMPC and specific applications. In particular we examine a realistic application setting for SMPC which we call Secure Outsourced Computation (SOC). Below we argue that this is a natural restriction and a practical setting; being particularly suited to the new paradigm of Cloud Computing. We show that by restricting the use of SMPC in this way we can avoid some of the restrictions required for general unconditionally secure SMPC.

Consider the following problem: a data holder wishes to outsource their data storage to a third party, i.e. a cloud computing provider. For example the data holder could be a government health care provider and they wish to store the health records of their population on a third party service. Clearly, there are significant privacy concerns with such a situation and hence the data holder is likely to want to encrypt the data before sending it to the service provider. However, this comes with a significant disadvantage; namely one cannot do anything with the data without downloading it and decrypting it.

This application scenario is in fact close to the common instantiation of practical proposed SMPC applications. Not only does this cover the problem of outsourced data storage, but it also encompasses a number of other applications; for example e-voting can be considered similarly, in that the data holders are now plural (the voters) and e-voting protocols often consist of a number of third parties executing the tallying computation on behalf of the set of voters. As another example the Danish sugar beat auction, in which SMPC was deployed for the first time, as described in “Secure multi-party computation goes live”, Financial Cryptography—FC 2009, Springer LNCS 5628, 325-343, 2009, P. Bogetoft, D. L. Christensen, I. Damgård, M. Geisler, T. Jakobsen, M. Kroigaard, J. D. Nielsen, J. B. Nielsen, K. Nielsen, J. Pagter, M. Schwartzbach and T. Toft, is also of this form. In the sugar beat auction example the data providers (the buyers and sellers) outsourced the computation of the market clearing price to a number of third party providers.

Essentially SOC consists of a set of entities I called the data providers which provide input, a set P of players which perform the computation and a set R of receivers which obtain the output of the computation. We assume that I and R may intersect, but we require that P does not intersect with I or R. The set of input players and receivers are assumed to be honest-but-curious, whereas the set P may consist of adaptive and/or active adversaries. We shall describe here, to simplify the discussion, the case where there is a single data provider and receiver, who is outsourcing computation and storage to a set of possibly untrusted third parties. It will be readily apparent that the principle may be extended to multiple data providers/receivers.

The notion of SOC has been considered a number of times in the literature before. From a practical perspective the proposed architecture most closely resembles the architecture behind the Sharemind system of D. Bogdanov, S. Laur and J. Willemson, Sharemind: A framework for fast privacy-preserving computations, European Symposium on Research in Computer Security—ESORICS 2008, Springer LNCS 5283, 192-206, 2008. This has notions of “Miner'”, “Data Doner” and “Client” which have roughly the same functionality as our players, data providers and data receivers. However, Sharemind implements standard SMPC protocols between three players working over the ring Z₂³², on the assumption of a single passive adversary. We however use this special application scenario to extend the applicability to different adversary structures and to allow smaller numbers of players.

Theoretically we are now able to perform SOC using only a single server by using the recently discovered homomorphic encryption schemes, such as M. van Dijk, C. Gentry, S. Halevi and V. Vaikuntanathan, “Fully homomorphic encryption over the integers”, Advances in Cryptology—Eurocrypt 2010; C. Gentry, “Fully homomorphic encryption using ideal lattices”, Symposium on Theory of Computing—STOC 2009, ACM, 169-178, 2009; C. Gentry, “A fully homomorphic encryption scheme”, Manuscript, 2009; or N. P. Smart and F. Vercauteren, “Fully homomorphic encryption with relatively small key and ciphertext sizes”, Public Key Cryptography—PKC 2010, Springer LNCS 6056, 420-443, 2010. However, these are only theoretical solutions and it looks impossible to provide a practical solution based on homomorphic encryption in the near future. In addition using a single server does not on its own protect against active adversaries, unless one requires the server to engage in expensive zero-knowledge proofs for each operation, which in turn will need to be verified by the receiver. An alternative to this approach is given in R. Gennaro, C. Gentry and B. Parno, “Non-interactive verifiable computing: Outsourcing computation to untrusted workers”, IACR e-print 2009/547, which combines the use of homomorphic encryption (to obtain confidentiality) with Yao's garbled circuits to protect against malicious servers.

Another (trivial) approach using a single server would be for the data provider to provide the server with a trusted module. The data can then be held encrypted on the server, and the trusted module could be used to perform the computation (with the server thereby just acting as a storage device). Clearly this means that the trusted module would need to be quite powerful, and would in some sense defeat the objective of the whole outsourcing process.

In A.-R. Sadeghi, T. Schneider and M. Winandy, “Token-based cloud computing: Secure outsourcing of data and arbitrary computations with lower latency.” Trust and Trustworthy Computing—TRUST 2010, another approach using a single server and a trusted module is proposed. Here the trusted module is used to compute a garbled circuit representing the function, with the evaluation of the garbled circuit being computed by the server. Using prior techniques the authors are able to compute the garbled circuit using a small amount of memory. However, this approach requires that the database is itself re-garbled for every query. The authors propose that this is also performed on the trusted module. Whilst this approach is currently deployable, it is not practical and it also requires that the trusted hardware module is relatively complex.

Another approach, and the one we take, to obtain an immediately practical solution to the problem of outsourcing computation, would be for the data holder to share his database between more than one cloud provider via a secret sharing scheme. Then to perform some computation the data holder simply instructs the multiple cloud providers to execute an SMPC protocol on the shared database.

As described herein, with this restricted notion of SMPC we can relax the necessary conditions for unconditional secure computation to be possible. This essentially arises due to the fact that the people doing the computation have no input to the protocol, and thus the usual impossibility result for general adversary structures does not apply. However, on its own SOC does not lead to more efficient and hence practical protocols; namely whilst we have relaxed the necessary conditions we have not relaxed the (equivalent) sufficient conditions. To enable the latter we make an additional set up assumption of the existence of small isolated secure trusted modules which are associated/attached to each player in P. This assumption enables us to significantly improve the performance of protocols compared to general SMPC, at the same time as simplifying the assumptions we require of the underlying communication network. Using additional hardware assumptions to enable SMPC is not new, indeed we discuss the prior work below, but the novelty of our approach is that the additional assumed hardware is relatively simple and cheap to produce. In particular the complexity of the hardware is orders of magnitude simpler compared to the above approach of A.-R. Sadeghi, T. Schneider and M. Winandy, “Token-based cloud computing: Secure outsourcing of data and arbitrary computations with lower latency.”

### SUMMARY OF THE INVENTION

According to the present invention, there is provided a method of performing a computation on data, the method comprising:
transmitting shares of the data to respective computation servers;
establishing respective connections between each of the computation servers and respective security modules, wherein each security module contains respective security data, the security data on the security modules being related by means of a Linear Secret Sharing Scheme;
computing respective shares of a computation result in the computation servers, using the respective shares of the data and the respective security data;
returning the shares of the computation result to a data owner; and
obtaining the computation result from the respective shares of the computation result.

Further, according to the present invention, there is provided a security system comprising a plurality of security modules, each having an interface for exclusive connection to a respective computation server, each storing a respective share of security data, and each being adapted to supply respective shares of the security data to their respective computation server on demand.

Thus, by using trusted hardware one can relax the sufficient condition in the above discussion, and the necessary condition can be relaxed by performing Secure

Outsourced Computation as opposed to general SMPC. At the same time the protocol we present becomes more efficient and requires less constraints on the overall network assumptions.

### BRIEF DESCRIPTION OF DRAWINGS

FIG. 1 is a schematic diagram illustrating the general form of a system operating in accordance with an aspect of the present invention.

FIG. 2 is a schematic diagram illustrating the general form of a second system operating in accordance with an aspect of the present invention.

FIG. 3 is a schematic diagram illustrating the general form of a computation server operating in accordance with an aspect of the present invention.

FIG. 4 is a schematic diagram illustrating the general form of a security module operating in accordance with an aspect of the present invention.

FIG. 5 is a schematic diagram illustrating the general form of a data source operating in accordance with an aspect of the present invention.

FIG. 6 is a flow chart, illustrating a method in accordance with an aspect of the present invention.

### DETAILED DESCRIPTION

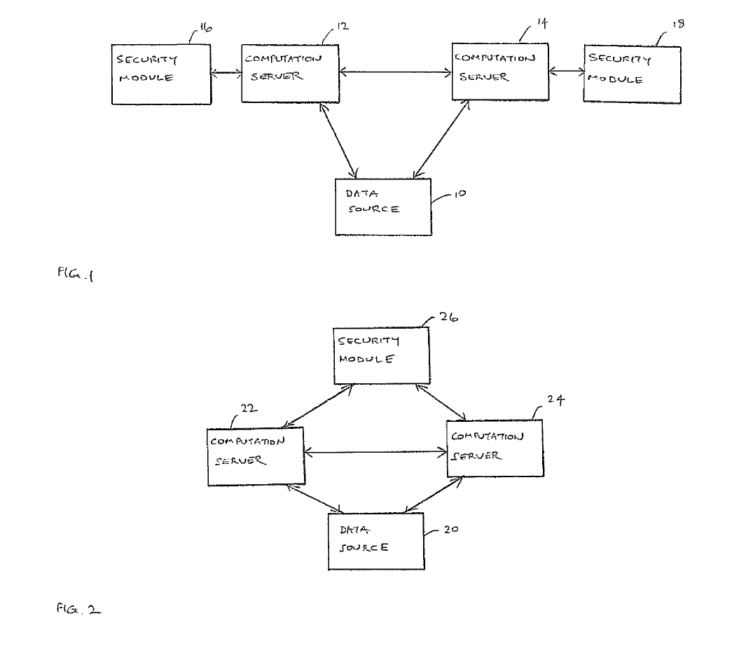

FIG. 1 shows a system that can perform secure outsourced computing. Specifically, FIG. 1 shows a system that includes a data source 10, which represents a party that owns some data, but wishes to outsource the storage of the data and the performance of computations on the stored data. The system therefore includes two computation servers 12, 14, which store the data, and are able to perform the computations, as described in more detail below. Each computation server 12, 14 is associated with a respective security module 16, 18. More specifically, each computation server 12, 14 is connected to a respective security module 16, 18. As described in more detail below, in this implementation, each security module is a separate simple piece of trusted hardware, supplied by a trusted manufacturer, who may be associated with the data source 10. Although the invention is described with reference to an example in which computation can be shared between two computation servers, the principle applies to any larger number of computation servers.

FIG. 2 is a schematic diagram illustrating the general form of a second system operating in accordance with an aspect of the present invention. FIG. 2 shows a system that includes a data source 20, which represents a party that owns some data, but wishes to outsource the storage of the data and the performance of computations on the stored data. The system therefore includes two computation servers 22, 24, which store the data, and are able to perform the computations, as described in more detail below. Each computation server 22, 24 is associated with connected to a security module 26. More specifically, each computation server 22, 24 is connected to a single security module 26. Again, in this implementation, the security module is a simple piece of trusted hardware, supplied by a trusted manufacturer, who may be associated with the data source 10.

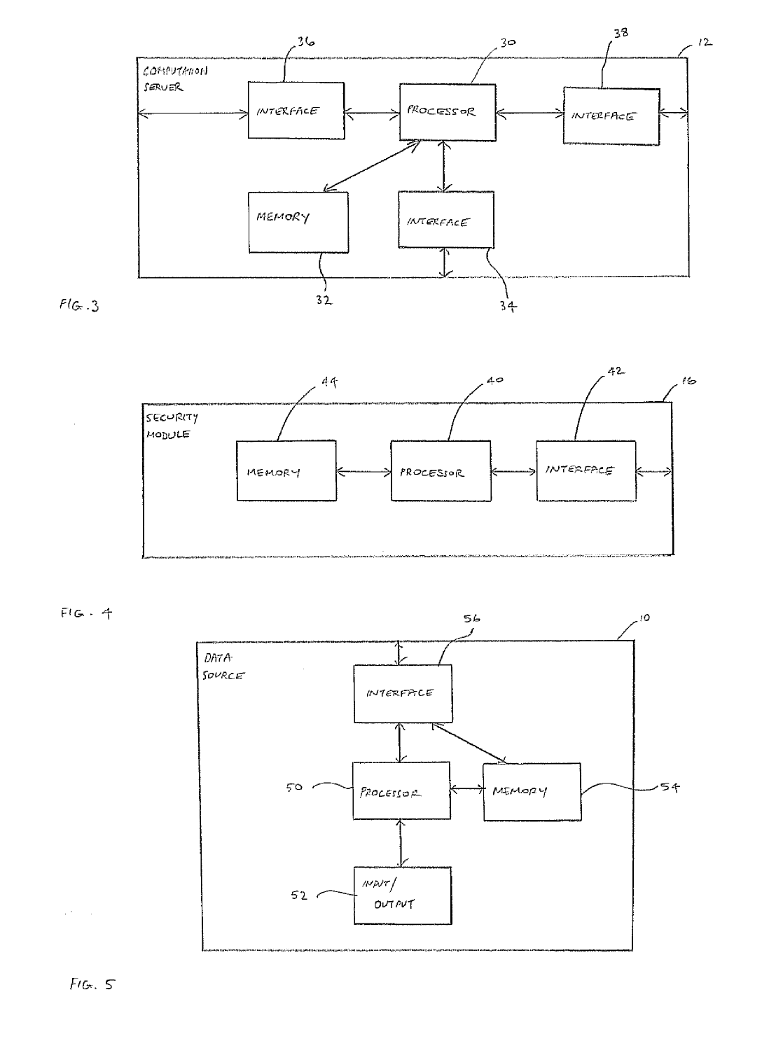

FIG. 3 is a schematic diagram illustrating the general form of a computation server operating in accordance with an aspect of the present invention. The device is described herein only in so far as is necessary for an understanding of the present invention. The computation server 12 is described here, but the computation server 14 may be similar in all essential details. The computation server 12 is a networked device that may be located remotely from the data source 10, and may be used by the data source 10 for the storage and processing of data, for example in a “cloud computing” application. The computation server 12 includes a processor 30 for performing the specified computation, and generally controlling the operation of the server. The processor 30 is able to access a memory 32, in which is stored the relevant data. In addition, the computation server has an interface 34 for communication over a secure network link with the data source 10, an interface 36 for communication over a secure network link with the other computation server 14, and an interface 38 for communication over a secure link with the security module 16. The security module 16 may be physically connected directly into the computation server 12.

FIG. 4 is a schematic diagram illustrating the general form of a security module operating in accordance with an aspect of the present invention. The device is described herein only in so far as is necessary for an understanding of the present invention. The security module 16 is described here, but the security module 18 may be similar in all essential details. The security module 16 may be in the form of a tamper-proof hardware device, which is intended to supply data only to its associated server 12. The connection may be over an encrypted link, or may be by means of a direct physical connection. Thus, the security module 16 has a processor 40, for controlling its operation, an interface 42 for connection to the interface 36 of the computation server 12, and a memory 44 for storing data to allow the process to be performed. Each security module generates pseudo-random numbers in sequence, as described in more detail below; is made and initialised so the sequences of multiple security modules are the same and in lockstep; is connected to a computation server, but never receives the data held by its computation server, and cannot communicate to the data source or to any computation server other than the computation server to which it is attached.

Where each of the computation servers is intended to be associated with a single security module 26, as shown in FIG. 2, the form of the security module 26 is generally similar to the form of the security module 16 shown in FIG. 4, but the device is such that the interface is able to connect to both computation servers 22, 24 by respective separate secure connections, and the security data (that is, the pseudo-random number sequences) for use by the computation servers are stored in such a way that each computation server can access only the security data that is intended for it. In this case, there are in effect two security modules as shown in FIG. 4, located in a single device.

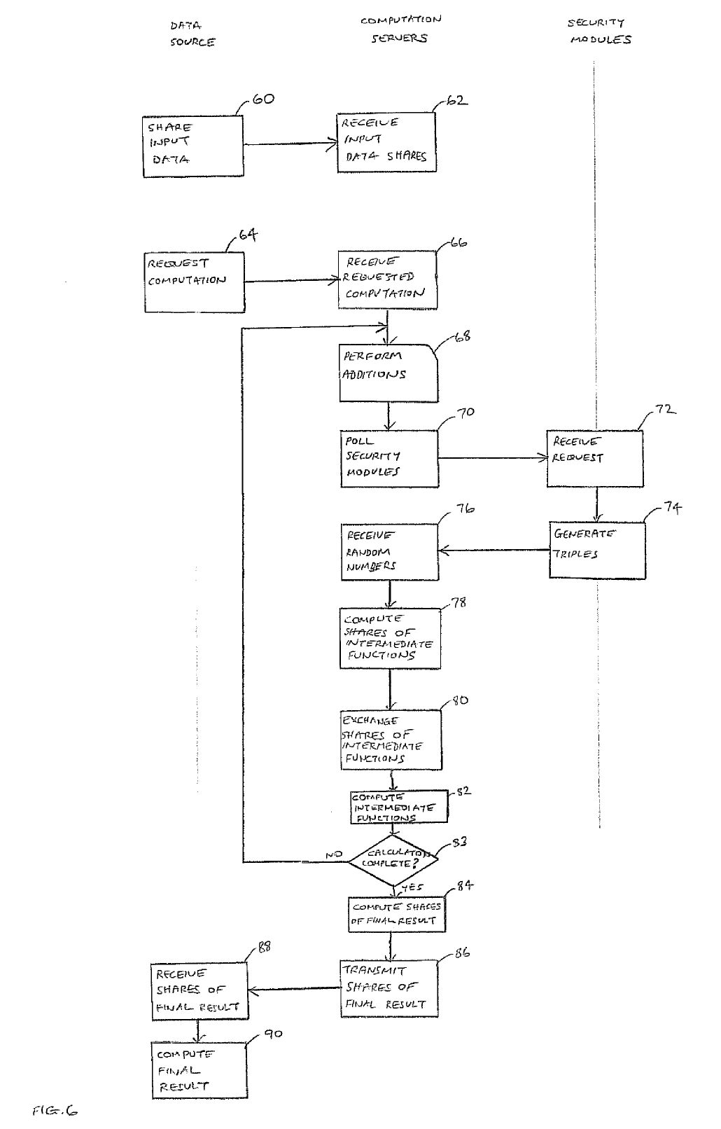

FIG. 5 is a schematic diagram illustrating the general form of a data source operating in accordance with an aspect of the present invention. The device is described herein only in so far as is necessary for an understanding of the present invention. The data source 10 has a processor 50, an input/output device 52 for receiving user inputs and presenting results to the user, a memory 54 for storing data, and an interface 56 for connection to the interface 34 of the computation server 12 over a secure link.

As described above, the process according to the invention is a form of secure multi-party computation (SMPC), but makes two mild simplifying assumptions to the standard SMPC model, enabling much more efficient protocols and reduced network assumptions. Our protocol requires, apart from the isolated trusted modules, only reliable broadcast between the set of players, and secure channels from the data providers to the set of players doing the computation. We also require secure communication from the trusted modules to their associated player, this can either be accomplished via encryption or more probably in practice by physical locality.

We start by presenting the necessary background notation and historical notes on standard SMPC. In standard SMPC the goal is for a set of players P={1, . . . , n} to compute some function f(x₁, . . . , xₙ) of their individual inputs xᵢ such that the players only learn the output of the function and nothing else.

It is perhaps worth presenting some definitions before we proceed. Adversaries (who are assumed to be one or more of the players) can be given various powers: a passive adversary (sometimes called “honest-but-curious”) is one which follows the protocol but who wishes to learn more than they should from the running of the protocol; an active adversary (sometimes called “malicious”) is one which can deviate from the protocol description, they also may wish to stop the honest players from completing the computation, or to make the honest players compute the wrong output; a covert adversary is one which can deviate from the protocol but they wish to avoid detection when they deviate. We talk of a singular adversary although they may be a set of actual players, such a single adversary can coordinate the operation of a set of adversarial players; this single adversary is often called a monolithic adversary. Adversaries can either have unbounded computing power or they can be computationally bounded.

As mentioned above, we also need to consider what communication infrastructure is assumed to be given. In the “secure channels model” we assume perfectly secure channels exist between each player; in the “broadcast model” we assume there exists a broadcast channel linking all players. Use of the broadcast channel model has a minor caveat: we assume not only that when an honest party broadcasts a message to all parties it is received by all parties, but also that a dishonest party cannot send different values to different honest parties as if it was a general broadcast. A broadcast model with both of these properties will be called a “consensus broadcast model”, if only the first property holds we will say we are in a “reliable broadcast model”.

An “adversary structure” Σ is a subset of 2^{P} with the following property, if A ∈ Σ and B ⊂ A then B ∈ Σ. The adversary structure defines which sets of parties the adversary is allowed to corrupt. In early work the adversary structure was a threshold structure, i.e. Σ contained all subsets of P of size less than or equal to some threshold bound t. The set of players which the adversary corrupts can be decided before the protocol runs, in which case we call such an adversary “static”; or it can be decided as the protocol proceeds, in which case we say the adversary is “adaptive”.

The first results were for computationally bounded passive adversaries; the case n=2 is provided by the classical result of Yao, A. Yao “Protocols for secure computation”, Foundations of Computer Science—FoCS '82, 160-164, ACM, 1987. Protocols that obtain security against active adversaries for the case n=2 are feasible but inefficient, the best current proposal being that of Y. Lindell and B. Pinkas, “An efficient protocol for secure two-party computation in the presence of malicious adversaries”, Advances in Cryptology—Eurocrypt 2007, Springer LNCS 4515, 52-78, 2007; protocols for covert adversaries have only recently been presented: Y. Aumann and Y. Lindell, “Security against covert adversaries: Efficient protocols for realistic adversaries”, Theory of Cryptography Conference—TCC 2007, Springer LNCS 4392, 137-156, 2007. For unbounded adversaries the first work on covert security is even more recent: I. Damgård, M. Geisler and J. B. Nielsen, “From passive to covert security at low cost”, Theory of Cryptography Conference—TCC 2010, Springer LNCS 5978, 128-145, 2010.

For more than two players the first result was for computationally bounded static, active adversaries where O. Goldreich, S. Micali and A. Wigderson, “How to play any mental game or a completeness theorem for protocols with honest majority”, Symposium on Theory of Computing—STOC '87, 218-229, ACM, 1987 showed one could obtain SMPC as long as (for threshold adversaries) we have t<n/2. The extension to adaptive adversaries was given in R. Canetti, U. Fiege, O. Goldreich and M. Naor, “Adaptively secure computation”, Symposium on Theory of Computing—STOC '96, 639-648, ACM, 1996, still with a bound of t<n/2. If we are prepared to only tolerate passive adversaries then we can obtain a protocol with t<n. It turns out, somewhat surprisingly, that the most efficient and practical protocols for more than two parties are those that give security against unbounded adversaries. Here we obtain (again for the threshold case):
Passive security, assuming secure channels, if and only if t<n/2
Active security, assuming secure channels, if and only if t<n/3
   (M. Ben-Or, S. Goldwasser and A. Wigderson, “Completeness theorems for non-cryptographic fault-tolerant distributed computation”, Symposium on Theory of Computing—STOC '88, 1-10, ACM, 1988, and D. Chaum, C. Crépeau and I. Damgård, “Multi-party unconditionally secure protocols”, Symposium on Theory of Computing—STOC '88, 11-19, ACM, 1988.)
Active security, assuming secure channels between players and a consensus broadcast channel, if and only if t<n/2 (assuming we want statistical security) or t<n/3 (if we want perfect security), T. Rabin and M. Ben-Or, “Verifiable secret sharing and multiparty protocols with honest majority”, Symposium on Theory of Computing—STOC '89, 73-85, ACM, 1989.

All these early protocols are based on the principle of using Shamir secret sharing (A.

Shamir, “How to share a secret”, Communications of the ACM, 612-613, 1979) to derive the underlying secret sharing scheme to implement the above protocols. For general adversary structures we define the following two properties:

The adversary structure Σ is said to be Q² if for all A, B ∈ Σ we have A∪B≠P.

The adversary structure Σ is said to be Q³ if for all A, B, C ∈ Σ we have A∪B∪C≠P.

We then have the following theorem (M. Hirt and U. Maurer, “Player simulation and general adversary structures in perfect multiparty computation”, Journal of Cryptology, 31-60, 2000):

SMPC is Possible:

Against adaptive passive adversaries if and only if Σ is Q², assuming secure channels;. Against adaptive active adversaries if and only if Σ is Q³, assuming pairwise secure channels and a consensus broadcast channel.

The proof of this theorem is via reduction to the threshold case, and is not practical. In R. Cramer, I. Damgård and U. Maurer, “Multiparty computations from any linear secret sharing scheme”, Advances in Cryptology—Eurocrypt '00, Springer LNCS 1807, 316-334, 2000, the authors show how to perform SMPC by generalising the above constructions using Shamir's secret sharing scheme to an arbitrary Linear Secret Sharing Scheme (LSSS). They define notions of what it means for a LSSS to be multiplicative, and strongly multiplicative. A multiplicative LSSS allows SMPC for passive adversaries, whereas a strongly multiplicative LSSS allows security against active adversaries.

Here, we shall mainly concentrate on the case of passive adversaries, leaving active adversaries to a discussion at the end. We end this section by examining the above theorem in the case of passive adversaries: That Σ being Q² is sufficient to perform unconditional SMPC follows from “Multiparty computations from any linear secret sharing scheme” cited above, which shows that one can construct for any Q² structure a multiplicative LSSS. The multiplicative property enables one to “write down” a protocol to enable SMPC. That Σ being Q² is a necessary condition follows from a result first expressed in M. Ben-Or, S. Goldwasser and A. Wigderson, “Completeness theorems for non-cryptographic fault-tolerant distributed computation”, Symposium on Theory of Computing—STOC '88, 1-10, ACM, 1988, (see R. Cramer, I. Damgård and J. B. Nielsen, “Multi-party Computation; An Introduction”, Lecture Notes, available from www.daimi.au.dk/˜ivan/smc.pdf for an explicit proof) which says that unconditional SMPC is impossible if one only has two parties; the non-Q² case can then be shown to be reducible to the case of two parties.

The process described herein makes use of a Linear Secret Sharing Scheme, and so it is perhaps instructive to introduce LSSS and how they can be constructed. We shall be only interested in ideal LSSS, since these provide the most efficient practical protocols with no increase in storage requirements. Note that since our presentation is focused on ideal schemes, to produce non-ideal schemes one needs to slightly adapt the following. A key point is that using our trusted hardware, and restricted application domain, we can make use of linear secret sharing schemes over F₂ with a small number of players.

An ideal LSSS M over a field F_{q} on n-players of dimension k is given by a pair (M,p) where M is a k×n matrix over F_{q} and p is a k-dimensional column vector over F_{q}. We write m₁, . . . , mₙ for the columns of M. Note that any non-zero vector p ∈ Span_{F}_{_{q}} (m₁, . . . , mₙ) can be selected; so one might as well select M and p such that p=(1, . . . , 1)^{T}. If T is a set of players we let M_{T} denote the matrix M restricted to the columns in T.

To share a secret s one generates a vector t ∈ F_{q}^{k} at random such that t·p=s and then one computes the shares as (s₁, . . . , sₙ)=s=t·M. Given a set of shares there is also a vector r such that s=r·(s₁, . . . , sₙ)^{T}, this vector is called the recombination vector.

If we set P={1, . . . , n} then the access structure Γ(M) for the ideal LSSS is given by: {A={a₁, . . . , aₜ} ⊂ Span_{F}_{_{q}}(mₐ₁, . . . , mₐₜ₎}.

Since we have assumed that p ∈ Span_{F}_{_{q}} (m₁, . . . , mₙ) we have P ∈ Γ(M), i.e. it is possible for all players to reconstruct the secret. The adversary structure is defined by Σ(M)=2^{P}\Γ(M). We sometimes write [s] for the sharing of s, [s]ᵢ=sᵢ for the ith component of the sharing of s, and if A ⊂ P we write [s]_{A} for the vector of shares of s held by the set of players A. We have H(s|[s]_{A})=H(s) if A ∈ Σ(M) and H(s|[s]_{A})=0 if A ∈ Γ(M).

The Schur (or Hadamard) product a [symbol] b of two vectors is defined to be their componentwise product. The LSSS M is said to be multiplicative if there exists a vector r_{M}∈F_{q}^{k} such that for two shared values s and s′ we have

s•s′=r_{M}•([s] [symbol] [s′]).

Note that we may have r=r_{M}, which is the case for Shamir secret sharing when t<n/2.

A LSSS M is said to be strongly multiplicative if for all Λ ∈ Γ(M) we have that M_{A} is multiplicative. Intuitively multiplicative means that the Schur product of sharings from all players is enough to determine the product of two secrets, whereas strongly multiplicative means that this holds even if you only have access to shares from a qualifying set of honest players.

In general SMPC it is not known how to construct ideal LSSS for all possible access structures; the construction in R. Cramer, I. Damgård and U. Maurer, “Multiparty computations from any linear secret sharing scheme”, Advances in Cryptology—Eurocrypt '00, Springer LNCS 1807, 316-334, 2000, which produces a multiplicative LSSS, from an LSSS with a Q² structure, results in a possible doubling of the share sizes and hence results in a non-ideal scheme. In our application we will not need to restrict to Q² structures, and so our restriction to ideal LSSS is without loss of generality. This solves a problem with SMPC in that one would prefer to use circuits over F₂, and a reasonably small number of players. Yet no ideal multiplicative LSSS exists over F₂ with less than six players. One can construct schemes with three players but then one loses the ideal nature of the LSSS. According to some aspects of the present invention, we allow LSSS over F₂ using at least two players by the use of security modules.

The first mention of the use of trusted modules in the context of secure multiparty computation seems to be Z. Benenson, F. C. Gartner and D. Kesdogan, “Secure multi-party computation with security modules”, Proceedings of SICHERHEIT, 2004. In this paper they assume each party is equipped with a trusted module and each person's trusted module is connected by a secure channel. The set of all trusted modules form what they call a “trusted system”. They then reduce the problem of secure MPC to the UIC problem (Uniform Interactive Consistency). The final solution requires O(n) rounds of computation and O(n³) messages, to compute any function as long as at most t<n/2 parties are corrupted. The model is such that parties may block communication to and from their trusted modules. Essentially the trusted modules swap their respective inputs and compute the function in the normal way. This solution has a number of major problems, the modules are not simple, they are highly complex, they need to be highly trusted and they need to be able to securely communicate with each other. On the other hand there is a proposed embodiment of this protocol using Java cards in M. Fort, F. Freiling, L. D. Penso, Z. Benenson and D. Kesdogan, “TrustedPals: Secure multiparty computation implemented with smart cards”, European Symposium on Research in Computer Security—ESORICS 2006, Springer LNCS 4189, 34-48, 2006. The question as to who produces and distributes the cards is not addressed.

Most of the recent work on secure hardware modules in SMPC is based on the following observation. We have already remarked that unconditionally secure general SMPC is impossible in the case of Q² structures, which includes the case of only two players. However, if we assume oracle access to an ideal functionality such as Oblivious Transfer than unconditionally secure SMPC becomes possible even for two players. Thus the question becomes one of implementing the oracle access to an OT functionality.

J. Katz, “Universally composable multi-party computation using tamper-proof hardware”, Advances in Cryptology—Eurocrypt 2007, Springer LNCS 4515, 115-128, 2007 looks at how the introduction of tamper proof hardware would enable one to get around various impossibility results in the UC framework. He uses tamper proof hardware to replace standard “set-up” assumptions, such as types of channels, a CRS or a public key infrastructure etc. He assumes that a set of parties want to compute the output of some function which depends on their inputs, and that each player can produce their own tamper proof hardware. In addition this hardware when given to another player may not be trusted by the receiving player. Once a player has handed over a token he is unable to send this token any messages. Using this trusted hardware Katz is able to produce a UC commitment functionality which enables him to perform secure MPC. This is very different from our own setup, in particular Katz assumes that each player can produce trusted hardware and that we are in the “standard” MPC setting where parties have inputs. In our setting we will have a single data owner who produces (or trusts) a single piece (essentially) of trusted hardware, the players are then computing on behalf of the data owner. This results in our trusted hardware being considerably simpler than the hardware envisaged in Katz's model. However, the restriction on the communication with the trusted module is preserved in our approach.

In N. Chandran, V. Goyal and A. Sahai, “New constructions for UC-secure computation using tamper-proof hardware”, Advances in Cryptology—Eurocrypt 2008, Springer LNCS 4965, 545-562, 2008,} Katz's work is extended to include modules for which players do not necessarily “know” the code within the token. This allows for modules to be resettable, and in particular stateless. Again the model of application use is very different from ours, and the modules have a much more complicated functionality (enhanced trapdoor permutations). In T. Moran and G. Segev, “David and Goliath commitments: UC computation for asymmetric parties using tamper proof hardware”, Advances in Cryptology—Eurocrypt 2008, Springer 4965, 527-544, 2008, the model is extended further, here again one is constructing general UC commitment functionality, but now it is assumed that only one party (Goliath) is able to produce tamper proof modules, whereas the other (David) has to ensure that this does not give Goliath an advantage. Again the underlying application is of the parties computing a function of their own inputs, and not ours of the parties computing a function on behalf of someone else. Katz's work is again extended in V. Goyal, Y. Ishai, A. Sahai, R. Venkatesan and A. Wadia, “Founding cryptography on tamper-proof hardware tokens”, Theory of Cryptography Conference—TCC 2010, Springer LNCS 5978, 308-326, 2010, where each player constructs a secure token and transmits it to the other player at the start of the protocol. Example protocols requiring both stateful and stateless modules are presented. In the case of stateful modules the authors obtain unconditionally secure protocols, and in the case of stateless modules they require the existence of one-way functions. For stateful modules the trusted modules are use once only modules. In V. Kolesnikov, “Truly efficient string oblivious transfer using resettable tamper-proof tokens”, Theory of Cryptography Conference—TCC 2010, Springer LNCS 5978, 327-342, 2010, another protocol for performing OT using tamper proof cards is presented.

In C. Hazay and Y. Lindell, “Constructions of truly practical secure protocols using standard smartcards”, Computer and Communications Security—CCS, 491-500, ACM, 2008, the authors examine how standard smart cards can be used to accomplish a number of cryptographic tasks, including ones related to what we discuss. Using their approach they manage to produce protocols which are simulation secure, and they provide some estimated run-times. Our approach is very different, we do not try to obtain a general OT functionality and do not reduce to the relatively expensive garbled circuit approaches to secure computation. In addition our trusted modules are reusable from one computation to the next, they are only bound to one particular data provider and not to a function or dataset. Our focus is on practicality as opposed to theoretical interest, and so our aim is to use simple trusted modules to enable more efficient and practical protocols.

Focusing on SOC as opposed to general SMPC provides a number of advantages. In this section we present our protocol assuming a semi-trusted third party. The role of this semi-trusted third party is to produce “correlated randomness” to the players who are computing the function, but otherwise takes no part in the protocol. We will then, later on, replace this single semi-trusted third party with multiple simple isolated trusted modules.

Q² is not a necessary condition. We first note that our division of players into players who compute P, and players I and R who input data and receive output, removes a major stumbling block to unconditionally secure computation. The standard argument which shows that Q² is a necessary condition is that if we had a Q² access structure, then we could reduce this to the problem of two player secure computation. However, any protocol between two players which was unconditionally secure, and for which the two players were trying to compute a function of their own inputs could not securely compute the AND functionality of two input bits. This negative result relies crucially on the fact that the function being computed is on two inputs; where one player knows one input and one player the other. In our application this does not hold, the players P doing the computation only know shares of the inputs to the function and not the inputs themselves. Thus SOC is possible for an arbitrary adversary structure.

Removing Q² as a sufficient condition. The above observation might remove the necessary condition of a Q² adversary structure it does not remove the sufficient condition. Using traditional protocols we still need a multiplicative LSSS to implement the basic SMPC protocol. And since multiplicative LSSS must necessarily have a Q² access structure we do not seem to have gained anything. Our protocol gets around this impasse by using an additional assumption, namely a semi-trusted third party.

This assumption might seem like “cheating” but it has a number of practical advantages. Firstly it enables the set of players P to be reduced to a set of size two if desired (in the passive case). More importantly as we will no longer require multiplicative LSSS, and only a simple LSSS with the required access structure this enables us to utilize functionality descriptions as arithmetic circuits over F₂ with a small number of players, whilst still using ideal LSSS. This provides greater efficiency and much reduced storage in the case of an application in which a large database is shared between the computation providers. In addition, as we explain later, many practical database operations are best described using F₂-arithmetic (i.e. binary) circuits as opposed to general Fₚ-arithmetic circuits for some prime p>2.

Our protocol makes use of reliable, but public, broadcast channels between the n servers, however the connection from the data provider to the servers, and the servers to the recipients must be implemented via secure channels. The computation servers may be adversarially controlled with respect to an adversary structure Σ (which will be the adversary structure of our underlying LSSS). In addition there is a special “server” T who is connected by secure channels to the other servers, this is our semi-trusted third party. The server T is trusted to validly follow its program, but it is assumed not to be trusted (or capable) to deal with any actual data. That the computing players are connected to the semi-trusted third party by secure channels is purely for exposition reasons; in the next section we will show how to replace the global semi-trusted third party with local isolated security modules.

The server T's job will be to perform the first stage of the asynchronous protocol of I. Damgård, M. Geisler, M. Kroigaard and J. B. Nielsen, “Asynchronous multiparty computation: Theory and implementation”, Public Key Cryptography—PKC 2009, Springer LNCS 5443, 160-170, 2009, i.e. the production of the random multiplication triples, leaving the actual servers to compute the second stage. With this set up T never takes any input and simply acts as a source of “correlated” random shared triples to the compute servers. Since T is trusted to come up with the random triples we no longer need a multiplicative LSSS to generate the triples, hence any LSSS will work. Thus we can use a very simple LSSS and cope (in the passive case over F₂) with only two servers.

One specific outsourced computation protocol will now be described, in general terms, with reference to FIG. 6, and with reference to a specific numerical example. The protocol proceeds as follows, assuming some fixed ideal LSSS M=(M,p) is chosen:

Given an input value x the input client (data source) generates a vector t ∈ F_{q}^{k} such that t·p=a. Then the input client computes the shares of x[x]=t·M. The value [x]ᵢ is transmitted (via a secure channel) to the computation server i.

The computation servers can locally compute the addition of their shares, since we are using a LSSS.

When the computation servers wish to compute the sharing of the multiplication of the shares representing x and y, they first poll T who securely provides to each server a random sharing [a], [b], [c] of three random field elements a, b and c such that c=a·b. The servers then locally compute the values [d]ᵢ=[x]ᵢ+[a]ᵢ and [e]ᵢ=[y]ᵢ+[b]ᵢ.

This pair of values ([d]ᵢ, [e]ᵢ) is publicly broadcast to each server, so that all servers can reconstruct d=x+a and e=y+b.

Now each party locally computes:

[z]ᵢ=[d·e]ᵢ−d·[b]ᵢ−e·[a]ᵢ+[c]ᵢ,

where [d·e]ᵢ is a trivial public sharing of the public product d·e.

The computation servers then send the shares [s]ᵢ of the value to be recombined to the recipient. The recipient recovers the shared value by solving the linear equations t·M=[s] for t and then uses this to compute s=t·p.

Thus, describing a specific worked example with reference to FIG. 6, in step 60, the data source 10 shares the input data with the selected computation servers 12, 14. For example, where the input data consists of three values: x=3, y=7, z=10

In this example, we are going to use the LSSS (Linear Shared Secret Scheme) given by

x=x₁+x₂ mod 19.

Thus, the data source 10 generates shares of the input data, for example:

| | | |
|---|---|---|
| x₁ = 7 | x₂ = 15 | from x = 3, because 3 = (7 + 15) mod 19 |
| y₁ = 1 | y₂ = 6 | from y = 7, because 7 = (1 + 6) mod 19, and |
| z₁ = 15 | z₂ = 14 | from z = 10, because 10 = (15 + 14) mod 19. |

In step 62, the computation server 12 receives first shares (x₁, y₁, z₁) of the input data and the computation server 14 receives second shares (x₂, y₂, z₂) of the input data securely delivered, for example using encryption. The data source is now free to delete his own values of x, y and z.

At some later stage, the data source may want to compute some function of the input data. For illustrative purposes, the invention is described with reference to a function t=(x+z)*(y+z) that involves both addition and multiplication of the input data values.

In step 64, the data source 10 tells the computation servers 12, 14 that this is what he wants them to compute, and the computation servers 12, 14 receive the requested computation in step 66.

The computation servers 12, 14 are able to perform additions independently of each other, and so, defining r=x+z and s=y+z, each of the computation servers 12, 14 is able to obtain a partial result using their shares of the input data in step 68 of the process. Thus:

| | | |
|---|---|---|
| r = r₁ + r₂ and | r₁ = x₁ + z₁ = 7 + 15 = 3 | r₂ = x₂ + z₂ = 15 + 14 = 10 |
| s = s₁ + s₂ and | s₁ = y₁ + z₁ = 1 + 15 = 16 | s₂ = y₂ + z₂ = 6 + 14 = 1. |

However, the computation of the multiplication step t=r*s must be performed by cooperation between the computation servers 12, 14, and this must be achieved in such a way that neither of the computation servers 12, 14 ever has enough of the data to be able to calculate the result for itself.

Thus, at this stage, when it is required to perform a multiplication operation, multiplying two numbers that are referred to as multiplicands, the computation server 12 has calculated a first share r₁ of the first multiplicand r and a first share s₁ of the second multiplicand s, while the computation server 14 has calculated a second share r₂ of the first multiplicand r and a second share s₂ of the second multiplicand s. In this illustrated example, these shares of the multiplicands have been obtained from the shares of the input data by performing addition operations, although in other situations the shares of the first and second multiplicands can be shares of the input data, or they can be shares of intermediate functions that have already been calculated by the calculation servers, as described in more detail below.

In order to perform the required multiplication, firstly, in step 70, the computation servers 12, 14 poll the trusted server T. The trusted server T module is tamper-proof and will only supply the intended data to the respective computation server 12, 14, either via its physical connection or via an encrypted link.

Thus, in step 72, the trusted server T receives the requests from the computation servers 12, 14 and, in step 74, generates respective “random” triples (a, b, c), such that c=a*b, i.e. (c₁+c₂)=(a₁+a₂)*(b₁+b₂). In this worked example:

| | |
|---|---|
| a₁ = 12 | a₂ = 12 |
| b₁ = 9 | b₂ = 1 |
| c₁ = 11 | c₂ = 1 |

In step 76, the computation server 12 receives its share (a₁, b₁, c₁) of the secret data from the trusted server T, and the computation server 14 receives its share (a₂, b₂, c₂) of the secret data from the trusted server T, and in step 78 the computation servers 12, 14 use their shares of the secret data to compute respective shares of intermediate functions d and e from the multiplicands r and s. Specifically: these intermediate functions are defined as d=r+a and e=s+b, and they are shared as d=d₁+d₂ and e=e₁+e₂.

Thus, the shares of the intermediate functions are defined in step 78 as:

| | |
|---|---|
| d₁ = r₁ + a₁ = 3 + 12 = 15 | d₂ = r₂ + a₂ = 10 + 12 = 3, and |
| e₁ = s₁ + b₁ = 16 + 9 = 6 | e₂ = s₂ + b₂ = 1 + 1 = 2. |

Then, in step 80, the computation servers 12, 14 exchange the computed shares of the intermediate functions d and e. That is, the computation server 12 sends the calculated values of d₁, and e₁ to the computation server 14, and the computation server 14 sends the calculated values of d₂, and e₂ to the computation server 12. These can be publicly broadcast, because they cannot on their own be used by an adversary without access to the other data values, even though the privacy of the data source is compromised if either of the computation servers finds out the data of the other computation server.

In step 82, the computation servers 12, 14 are then able to compute the values of the intermediate functions d and e, as

d=d₁+d₂=15+3=18, and

e=e₁+e₂=6+2=8.

In step 83, it is determined whether these intermediate functions can be used to generate the final result, or whether further operations are required. If the calculation is not complete, and further multiplications are required, the process returns to step 68, where it is first determined if any additional addition operations are performed, and then any additional multiplication is performed.

As mentioned above, in this simple illustration, the final wanted result is

t=(x+z)*(y+z), that is:

t=r*s.

Thus, in step 83, it is determined that no further addition or multiplication operations are required, and the process can pass to step 84, in which the shares of the final result are calculated.

In view of the definition of the intermediate functions d and e, the final wanted result t=(x+z)*(y+z)=r*s can be rewritten as:

t=(d−a)*(e−b), which in turn can be expanded as:

t=e*d−a*e−b*d+a*b.

The property of the secret data that c=a*b can be used. Thus:

t=e*d−a*e−b*d+c.

This can be divided into parts that can be calculated in step 84 by the two computation servers 12, 14 respectively.

t=e*d−[a₁+a₂]*e−[b₁+b₂]*d+[c₁+c₂], which can be rearranged as:

t=e*d+[c₁−a₁*e−b₁*d]+[c₂−c₂*e−b₂*d],

where the first term can be calculated by either of the computation servers 12, 14 because they have both calculated the values of d and e, the value of the term in the first bracket can be calculated by the computation server 12 because it uses the share (a₁, b₁, c₁) of the secret data that it received from the trusted server T, and the value of the term in the second bracket can be calculated by the computation server 14 because it uses the share (a₂, b₂, c₂) of the secret data that it received from the trusted server T.

In the worked example, the [e*d] term is calculated by the computation server 12, and so the shares of the final result are:

t₁=e*d−a₁*e−b₁*d+c₁=8*18−12*8−9*18+11=11, and

t₂=−a₂*e−b₂*d+c₂=−12*8−1*18+1=1

In step 86, the computation servers 12, 14 securely send t₁ and t₂ back to the data source 10. In step 88 the data source receives these shares of the final result and in step 90 he computes the final result as:

t=t₁+t₂=12.

As a check, we can see that (x+z)*(y+z)=13*17=12 mod 19.

The above protocol is the second stage of the asynchronous protocol of I. Damgård, M. Geisler, M. Kroigaard and J. B. Nielsen, “Asynchronous multiparty computation: Theory and implementation”, Public Key Cryptography—PKC 2009, Springer LNCS 5443, 160-170, 2009, with the trusted server providing the first stage, mapped over to our SOC application scenario.

We now look at the “code” for our semi-trusted third party T. When T is polled it executes the following steps:

t₁, t₂ ← F_{q}^{k}.
a ← t₁ · p; b ← t₂ · p; c ← a · b.
t₃ ← F_{q}^{k} such that t₃ · p = c.
[a] ← t₁ · M; [b] ← t₂ · M; [c] ← t₃ · M.
Send player i the tuple ([a]ᵢ, [b]ᵢ, [c]ᵢ).

One should ask first what have we gained by introducing a semi-trusted third party? After all we have assumed a semi-trusted third party T, so why do we not just pass the data to T and get T to compute the function? However, this would mean that T is fully trusted as it sees the inputs. In the above protocol the party T does not see any inputs, indeed they do not see anything bar requests to produce random numbers. Thus whilst T is trusted to produce the “correlated randomness” it is not trusted to do anything else.

Note that the semi-trusted third party only needs to be trusted by the person in the SOC who is receiving the data. Although in practice commercial concerns of the P who are being paid to compute and store the data may require them to also trust the party T. It is relatively straightforward for the players to determine whether T is honest or not (or possibly faulty). The first method would be to require T to output a zero-knowledge proof of correctness of its output. However, a more efficient second method would be for the players to occasionally engage in a protocol to prove they have a consistent output from T. This last cut-and-choose technique can be done at any stage, since T has no idea as to whether its output will be used for computation or for validation. Problems occur if we assume that T can be part of the adversary structure Σ for our overall protocol, i.e. an adversary can control both T and one of the players. These are not insurmountable, but require more complex protocols to deal with, which is why we have assumed that T is semi-trusted.

A more problematic issue is that T is a single point of failure and needs to communicate with the players via a secure channel. For static adversaries this is not a problem, but could be an issue for adaptive adversaries as it would require a form of non-committing encryption. So whilst we have simplified things somewhat the use of a single semi-trusted third party is not ideal and produces problems of its own. This is why we now suggest to replace the centralised semi-trusted third party, with isolated semi-trusted tamper proof modules; one for each server, e.g. the security modules 16, 18 shown in FIG. 1, or the security module 26 shown in FIG. 2 that contains the functionality of the two security modules.

We notice that the functionality of the semi-trusted party Tin our protocol can be localised to each player performing the computation by the use of isolated tamper proof trusted modules. In particular we assume a set of trusted modules Tᵢ such that:
The trusted modules Tᵢ are produced by some third party and distributed to the compute servers, possibly (in the data outsourcing scenario) by the data provider.
The manufacturer has embedded in each T the same long term secret key k_{T}, which is the index to some pseudorandom function family PRF_{kT}(m).
Each module is tamper proof, and will only supply data to its intended computation server. One could either do this cryptographically (via encryption) or physically (by locality) depending on the application scenario.

As a possible additional functionality we may require some process to check the outputs of the Tᵢ, i.e. that the manufacturer of the trusted modules has proceeded validly. But this can be accomplished using the cut-and-choose methodology outlined above, combined with some form of data authentication from the modules.

Our main protocol is now modified as follows: At the start of the protocol the servers compute a shared one-time nonce N, to which they have all contributed entropy. For example they could all commit to a value Nᵢ, and then after all have committed, they then reveal the Nᵢ and compute N=N₁⊕ . . . ⊕Nₙ. The nonce is used to make sure each protocol run uses different randomness. Each multiplication gate is assumed to have a unique number g associated to it.

Now when a server i requires the randomness for a particular gate g in a computation associated with nonce N, it passes the values g and N to the trusted module Tᵢ. As before we write m₁, . . . , mₙ for the columns of M, we assume that trusted module Tᵢ has embedded into it mᵢ only. The trusted module Tᵢ now executes the following code, where we have assumed that p=(1, . . . , 1)^{T} for simplicity of exposition.

u ← PRF_{kT}(g∥0∥N) where u ∈ F_{q}^{k}.
v ← PRF_{kT}(g∥1∥N) where v ∈ F_{q}^{k}.
a ← u · p; b ← v · p; c ← a · b.
w ← PRF_{kT}(g∥2∥N) where w ∈ F_{q}^{k-1}.
wₖ ← c − Σᵢ₌₁^{k-1} wᵢ.
[a]ᵢ ← u · mᵢ; [b]ᵢ ← v · mᵢ; [c]ᵢ ← w · mᵢ.
Output the tuple ([a]ᵢ, [b]ᵢ, [c]ᵢ).

Note the function PRF can be implemented in practice using any standardized key generation function, for example one based on a cryptographic hash function or a block cipher.

The key observation is that these modules are incredibly simple and easy to implement with only a few gates, especially if one takes F_{q} to be the binary field. One may be concerned about protecting them against side channel attacks; for example an adversarial server may try to learn the key k_{T} embedded within the device. However, such protection can be done using standard defences employed in banking cards etc. Note that since our main protocol using isolated trusted modules no longer requires secure channels: thus the need for, in the adaptive adversary setting, of using non-committing encryption is removed. Although one would still need this when there is a single semi-trusted third party to secure the channels from this party to the servers.

One caveat is perhaps worth noting at this stage. Whilst our security theorem in the case of having a single semi-trusted third party was for unbounded adversaries we are unable to achieve such security when the semi-trusted party is split into trusted modules as above. This is because an unbounded adversary could simply “learn” the key k_{T} for the PRF after only a small amount of interaction with a single module. Hence, security in this setting is only provided against computationally bounded adversaries who cannot break the PRF.

To deal with active adversaries in the player set P one needs to have a method to recover from errors introduced by the bad players. The only places where an honest players computation can be affected by a dishonest player are during the broadcast in the multiplication protocol and the recombining step. To enable the honest player to recover the underlying secret we hence require some form of error correction. To a LSSS we can associate a linear [n, k, d]-code as follows, each set of shares [s] becomes an element in the code C. We let Supp(x) for some vector x denote the set Supp(x)={i: xᵢ≠0}.

Let Σ+⊂Σ denote a subset of the adversary structure. We say that Σ′ is “correctable” if for all c ∈ F_{q}ⁿ we have that, for all (e, e′) ∈ F_{q}ⁿ with Supp(e), Supp(e′) ∈ Σ′, and for all t, t′ ∈ F_{q}ⁿ with c=e+t·M=e′+t′−M, we have t·p=t′·p. Note a correctable subset Σ′ is one for which on receipt of a set of shares c which may have errors introduced by parties in B for B ∈ Σ′, it is “possible” to determine what the underlying secret should have been. For the small values of q and n we envisage in our application scenario, we can write down the correction algorithm associated to the set Σ′ as a trivial enumeration.

We that that Σ′ is “detectable” if for all e ∈ F_{q}ⁿ with Supp(e) ∈ Σ′ and e≠0, and for all t ∈ F_{q}^{k} then e+t·M is not a code-word. Note a detectable subset Σ′ is one for which if any errors are introduced by parties in B for B ∈ Σ′, we can determine that errors have been introduced but possibly not what the error positions are.

If a set Σ′ is detectable then this corresponds to a set of possible adversary structures for which we can tolerate a form of covert corruption. Namely, we are unable to identify exactly which parties are corrupt, but we are able to determine that some parties are trying to interfere with the computation. Note, this is slightly weaker than the standard notion of covert adversary, since we can detect that someone has cheated but not who.

If a set Σ′ is correctable then in our main protocol, any error introduced by a set parties B ∈ Σ′, can be corrected. Thus our protocol can tolerate active adversaries lying in Σ′. For q=2 and n=2 however any correctable set must have Σ′=0. As a bigger example consider the LSSS M=(M,p) over F₂ given by:

$$M = ( \begin{matrix}1 & 1 & 0 & 0 \\ 0 & 0 & 1 & 1\end{matrix} )$$

$$p = ( \begin{matrix}1 \\ 1\end{matrix} )$$

This has adversary structure Σ(M)={{1}, {2}, {3}, {4}, {1, 2}, {3, 4}}.

The subset Σ′={{1}, {2}, {3}, {4}} (and any subset thereof) is a detectable set, essentially because the underlying code is the repetition code on two symbols. The following subsets (and any subset thereof) is a correctable set:

{{1}, {3}} or {{1}, {4}} or {{2}, {3}} or {{2}, {4}}.

A subset Σ′ which is either correctable or detectable therefore corresponds to a mixed adversary structure.

We end this section with two remarks on how the above discussion differs from prior notions in the literature. Firstly, the notion of error correction used above is not the usual notion. We do not require that there is an algorithm which recovers the entire code-word, or equivalently recovers all of the shares, only that there is an algorithm which recovers the underlying shared secret itself. This is a possibly simpler error correction problem. The traditional notion of correction is known to be possible, for any error introduced by a subset of parties in Σ, if and only if the LSSS is Q³. Determining a criteria for which a LSSS admits an adversary structure Σ which is itself correctable (in our sense) is an interesting open problem.

Secondly, we associate the secret sharing scheme with the [k, n, d] code consisting of its shares. This is because the parties “see” a code word in this code. Usually one associates a secret sharing scheme with the [k+1, n, d] code in which one also appends the secret to the code-word. In such a situation correction is about recovering the one erased entry in the code word given some errors in the other entries.

We now outline two implementation aspects which we feel are worth pointing out.

Up to now we have assumed that the data provider is connected to the servers by pairwise secure channels and that when the data is first transferred to the servers it needs to be sent n times (one distinct transmission for each server). In this section we show a standard trick which enables the data transfer to happen in one-shot, thereby reducing the amount of work for the data provider. The method is a generalisation to arbitrary LSSS of the threshold protocol described in P. Bogetoft, D. L. Christensen, I. Damgård, M. Geisler, T. Jakobsen, M. Kroigaard, J. D. Nielsen, J. B. Nielsen, K. Nielsen, J. Pagter, M. Schwartzbach and T. Toft, “Secure multi-party computation goes live”, Financial Cryptography—FC 2009, Springer LNCS 5628, 325-343, 2009, which itself relies on the transform from replicated secret sharing schemes to LSSS schemes presented in R. Cramer, I. Damgård and Y. Ishai, “Share conversion, pseudorandom secret-sharing and applications to secure computation”, Theory of Cryptography Conference—TCC 2005, Springer LNCS 3378, 342-362, 2005. We recap on this technique here for completeness.

Suppose the data provider has input x₁, . . . , xₜ which he wishes to share between the servers P₁, . . . , Pₙ with respect to the LSSS M=(M,p). Let T be the collection of maximal unqualified sets of M. For every set T ∈ T, let ω_{T} be a row vector satisfying ω_{T}·M_{T}=0 and ω_{T}·p=1. The vector ω_{T} is used to construct known valid sharings of 1 which are zero for players in the unqualified set T. We set [t_{T}]=ω_{T}·M.

It is not clear that such an ω_{T} always exists however observe that the set P\T is minimally qualified and therefore the system of equations ω_{T}·M=ω_{T}·(M_{T}∥M_{P\T})=(\vec{0}∥\vec{v}) has nontrivial solutions (else we would need an extra contribution from a player Pᵢ ∈ T so the set P\T would not be minimally qualified).

To send the data to the servers the client now selects a key K_{T}, for each T ∈ T, to a pseudorandom function F. These keys are then distributed such that Pᵢ obtains key K_{T} if and only if i ∉ T. This distribution is done once, irrespective of how much data needs to be transmitted, and can be performed in practice by encryption under the public key of each server. The crucial point to observe is that this distribution of values K_{T} is identical to the distribution of shares with respect to the replicated secret sharing, of the value ⊕ T ∈ T K_{T} with respect to the access structure defined by our LSSS M. We use an analogue of this fact to distribute the data in one go.

The data provider then computes for each value of xⱼ

$${y}_{j} = {x}_{j} - {\sum }_{T ∈ T}^{ } {F}_{{K}_{T}} ( j )$$

and broadcasts the values yⱼ, for j=1, . . . , t, to all servers. Player i computes his sharing of xⱼ, namely [xⱼ]ᵢ as

$${⌊ {x}_{j} ⌋}_{i} = {y}_{j} \cdot {[ {t}_{T} ]}_{i} + {\sum }_{T ∈ T , i ∉ T} {F}_{{K}_{T}} ( j )$$

Note, due to the construction of the sharings [t_{T}], namely that [t_{T}]ᵢ=0 if i ∉ T, we have

$${[ {x}_{j} ]}_{i} = ( {y}_{j} + {\sum }_{T ∈ T}^{ } {F}_{{K}_{T}} ( j ) ) \cdot {[ {t}_{T} ]}_{i}$$

from which it follows, by linearity, that [xⱼ]ᵢ is a valid sharing of something with respect to the LSSS M. That [xⱼ]ᵢ is a sharing of the value [yⱼ] follows since [t_{T}] is a sharing of one.

A major practical benefit of our combination of application scenario and protocol is that one can use ideal LSSS over F₂ with a small number of players. In most data outsourcing scenarios the major computation is likely to be comparison and equality checks between data as opposed to arithmetic operations. For example most simple SQL queries are simple equality checks, auctions are performed by comparisons, etc. Whilst arithmetic circuits over any finite field can accomplish these tasks, the overhead is more than when using arithmetic circuits over F₂.

For example consider a simple n-bit equality check between two integers x and y. If one uses arithmetic circuits over Fₚ with p>2ⁿ then one can perform this comparison by securely computing (x−y)^{{p-1}} and applying Fermat's Little Theorem. This requires O(log p) multiplications, and in particular (3/2) log p operations on average. Alternatively using an arithmetic circuit over F₂, we hold all the bits xᵢ and yᵢ of x and y individually and then compute zᵢ= [symbol] (xᵢ ⊕ yᵢ), which is a linear operation and then Π zᵢ, which requires n multiplications.

Further benefits occur with this representation when one needs to perform an operation such as x<y. Here when working over Fₚ one converts the integers to bits, and then performs the standard comparison circuit. But not only is converting between bit and normal representations expensive, the comparison circuit involves a large number of multiplications (due to xor not being a linear operation over Fₚ). If we work on bits all the time by working over F₂, then both of these problems disappear.

We have therefore described a solution to the problem of Secure Multi-Party Computation, in particular for use in Secure Outsourced Computation, a pressing problem as the world moves to a Cloud Computing infrastructure. Whilst homomorphic encryption could solve such a problem using only a single cloud provider such schemes are not yet fully practical. Hence, the solution we have taken uses multiple (possibly as few as two) cloud providers and adapts techniques from general Secure Multi-Party Computation to this specific problem. The resulting protocol, which makes use of a minimal isolated trusted module, reduces the requirements on the network and also improves on performance when compared to solutions based on general Secure Multi-Party Computation protocols.

1. A method of performing a computation on data, the method comprising:
transmitting a first share of the data to a first computation server;
transmitting a second share of the data to a second computation server;
when the computation includes a multiplication,
obtaining a first share of a first multiplicand and a first share of a second multiplicand from the first share of the data in the first computation server;
obtaining a second share of the first multiplicand and a second share of the second multiplicand from the second share of the data in the second computation server;
establishing a connection between the first computation server and a security module associated with the first computation server, wherein the security module associated with the first computation server contains first security data;
establishing a connection between the second computation server and a security module associated with the second computation server, wherein the security module associated with the second computation server contains second security data, the second security data being related to the first security data by means of a Linear Secret Sharing Scheme;
computing a first share of a multiplication result in the first computation server, using the first share of the first multiplicand and the first share of the second multiplicand and the first security data; and
computing a second share of the multiplication result in the second computation server, using the second share of the first multiplicand and the second share of the second multiplicand and the second security data.

2. A method as claimed in claim 1, comprising, when a result of the computation is said multiplication result;
returning the first and second shares of the computation result to a data owner; and
obtaining the computation result from the first and second shares of the computation result.

3. A method as claimed in claim 1, wherein the steps of computing the first and second shares of the multiplication result comprise:
computing a first share of an intermediate function in the first computation server,
computing a second share of an intermediate function in the second computation server,
exchanging the first and second shares of the intermediate function between the first and second computation servers,
computing the first share of the multiplication result in the first computation server, using the first share of the first multiplicand and the first share of the second multiplicand and the first and second shares of the intermediate function; and
computing the second share of the multiplication result in the second computation server, using the second share of the second share of the first multiplicand and the second share of the second multiplicand and the first and second shares of the intermediate function.

4. A method as claimed in claim 1, wherein the first and second shares of the security data together form a multiplication triple.

5. A method as claimed in claim 1, wherein the security module associated with the first computation server and the security module associated with the second computation server comprise separate devices.

6. A method as claimed in claim 1, wherein the security module associated with the first computation server and the security module associated with the second computation server are formed in a single device.

7. A method of performing a computation on data, the method comprising:
transmitting shares of the data to respective computation servers;
establishing respective connections between each of the computation servers and a respective security module containing respective security data for each computation server, the security data for the computation servers being related by means of a Linear Secret Sharing Scheme;
computing respective shares of a computation result in the computation servers, using the respective shares of the data and the respective security data;
returning the shares of the computation result to a data owner; and
obtaining the computation result from the respective shares of the computation result.

8. A method as claimed in claim 7, wherein the computation comprises a sequence of additions and multiplications, and wherein the multiplications are performed by the computation servers using their own shares of the data, and multiplications are performed by the computation servers using the respective shares of the data and the respective security data based on interaction between the computation servers.

9. A method as claimed in claim 7, wherein the step of computing the respective shares of a computation result in the computation servers comprises:
in each computation server, computing a respective share of the computation result, using the respective share of the data and the respective share of security data obtained from the respective security module, and interacting with the other computation servers.

10. A security system comprising a plurality of security modules, each having an interface for exclusive connection to a respective computation server, each storing a respective share of security data, and each being adapted to supply respective shares of the security data to their respective computation server on demand.

11. A security system as claimed in claim 10, wherein the plurality of security modules are located in a single device.

12. A security system as claimed in claim 10, wherein the plurality of security modules are located in separate devices.

13. A security system as claimed in claim 10, wherein the plurality of security modules have interfaces for remote connection to the respective computation servers.

14. A security system as claimed in claim 10, wherein the plurality of security modules have interfaces for direct physical connection to the respective computation servers.

15. A security system as claimed in claim 10, wherein each of plurality of security modules stores security data in accordance with a linear secret sharing scheme.

16. A security system as claimed in claim 15, wherein each of plurality of security modules stores a respective share of a multiplication triple.

17. A security system as claimed in claim 16, wherein each of the plurality of security modules stores a respective share of a plurality of multiplication triples, and is adapted to supply a respective share of the multiplication triple to the respective computation server on demand in synchronism with each other security module.

18. A security system as claimed in claim 15, in which errors in the computation introduced by sets of computation servers can be detected or corrected, provided that the subset of error-inducing servers are contained in a detectable or correctable subset of the adversary structure of the linear secret sharing scheme.
